(19) United States
(12) Patent Application Publication
(10) Pub. No.: US 2005/0051196 A1
(43) Pub. Date: Mar. 10, 2005

(54) Developer dispensing apparatus with adjustable knife ring

(75) Inventors: Yao-Hwan Kao, Hsinchu County (TW); Ming-Yeon Hung, Hsin-Chu (TW); Po-Chang Huang, Taipei City (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.,

(21) Appl. No.: 10/658,708

(22) Filed: Sep. 8, 2003

(51) Int. Cl. B08B 3/02

(52) U.S. Cl. 134/25.4; 134/33; 134/95.1; 134/103.1; 134/148; 134/153; 134/183; 134/902

(57) ABSTRACT

A developer dispensing apparatus for dispensing developer solution onto a semiconductor wafer substrate which has a vertically-adjustable knife ring. The knife ring is vertically actuated in the apparatus by pressurized air or fluid. In an application, the gap distance between the upper edge of the knife ring and the backside of the wafer is initially adjusted to a minimum value as the developer solution is dispensed onto the wafer, by adjusting the knife ring to the uppermost position in the apparatus.

### FIELD OF THE INVENTION

The present invention relates to apparatus for dispensing developer solution onto a wafer in the fabrication of integrated circuits on the wafer. More particularly, the present invention relates to a developer dispensing apparatus including a vertically-adjustable knife ring which prevents wafer backside developer contamination and facilitates rinsing of the wafer backside after developer application.

### BACKGROUND OF THE INVENTION

The fabrication of various solid state devices requires the use of planar substrates, or semiconductor wafers, on which integrated circuits are fabricated. The final number, or yield, of functional integrated circuits on a wafer at the end of the IC fabrication process is of utmost importance to semiconductor manufacturers, and increasing the yield of circuits on the wafer is the main goal of semiconductor fabrication. After packaging, the circuits on the wafers are tested, wherein non-functional dies are marked using an inking process and the functional dies on the wafer are separated and sold. IC fabricators increase the yield of dies on a wafer by exploiting economies of scale. Over 1000 dies may be formed on a single wafer which measures from six to twelve inches in diameter.

Various processing steps are used to fabricate integrated circuits on a semiconductor wafer. These steps include deposition of a conducting layer on the silicon wafer substrate; formation of a photoresist or other mask such as titanium oxide or silicon oxide, in the form of the desired metal interconnection pattern, using standard lithographic or photolithographic techniques; subjecting the wafer substrate to a dry etching process to remove the conducting layer from the areas not covered by the mask, thereby etching the conducting layer in the form of the masked pattern on the substrate; removing or stripping the mask layer from the substrate typically using reactive plasma and chlorine gas, thereby exposing the top surface of the conductive interconnect layer; and cooling and drying the wafer substrate by applying water and nitrogen gas to the wafer substrate.

Photoresist materials are coated onto the surface of a wafer by dispensing a photoresist fluid typically on the center of the wafer as the wafer rotates at high speeds within a stationary bowl or coater cup. The coater cup catches excess fluids and particles ejected from the rotating wafer during application of the photoresist. The photoresist fluid dispensed onto the center of the wafer is spread outwardly toward the edges of the wafer by surface tension generated by the centrifugal force of the rotating wafer. This facilitates uniform application of the liquid photoresist on the entire surface of the wafer.

During the photolithography step of semiconductor production, light energy is applied through a reticle mask onto the photoresist material previously deposited on the wafer to define circuit patterns which will be etched in a subsequent processing step to define the circuits on the wafer. A reticle is a transparent plate patterned with a circuit image to be formed in the photoresist coating on the wafer. A reticle contains the circuit pattern image for only a few of the die on a wafer, such as four die, for example, and thus, must be stepped and repeated across the entire surface of the wafer. In contrast, a photomask, or mask, includes the circuit pattern image for all of the die on a wafer and requires only one exposure to transfer the circuit pattern image for all of the dies to the wafer.

The numerous processing steps outlined above are used to cumulatively apply multiple electrically conductive and insulative layers on the wafer and pattern the layers to form the circuits. The final yield of functional circuits on the wafer depends on proper application of each layer during the process steps. Proper application of those layers depends, in turn, on coating the material in a uniform spread over the surface of the wafer in an economical and efficient manner.

Spin coating of photoresist on wafers, as well as the other steps in the photolithography process, is carried out in an automated coater/developer track system using wafer handling equipment which transport the wafers between the various photolithography operation stations, such as vapor prime resist spin coat, develop, baking and chilling stations. Robotic handling of the wafers minimizes particle generation and wafer damage. Automated wafer tracks enable various processing operations to be carried out simultaneously. Two types of automated track systems widely used in the industry are the TEL (Tokyo Electron Limited) track and the SVG (Silicon Valley Group) track.

A typical method of forming a circuit pattern on a wafer includes introducing the wafer into the automated track system and then spin-coating a photoresist layer onto the wafer. The photoresist is next cured by conducting a soft bake process. After it is cooled, the wafer is placed in an alignment and exposure apparatus, such as a stepper, which aligns the wafer with an array of die patterns etched on the typically chrome-coated quartz reticle. When properly aligned and focused, the stepper exposes a small area of the wafer, then shifts or “steps” to the next field and repeats the process until the entire wafer surface has been exposed to the die patterns on the reticle. The photoresist, which may be either positive or negative, is exposed to light through the reticle in the circuit image pattern. Negative photoresist is cross linked, or hardened, by exposure to UV light in the image of the circuit pattern, and therefore the exposed regions are rendered insoluble and the unexposed regions are rendered soluble to developer solution. The light-exposed regions of positive photoresist, on the other hand, are rendered soluble to developer solution after exposure to the UV light, whereas the unexposed regions remain insoluble to the developer solution. After the aligning and exposing step, the wafer is exposed to post-exposure baking and then is developed and hard-baked, and finally, inspected.

During the photoresist development step, a liquid chemical developer is applied to the wafer to dissolve the soluble regions of the resist that were formed during mask or reticle exposure. Accordingly, in the case of negative photoresist, the soluble, unexposed regions of the photoresist are dissolved and the insoluble, cross-linked exposed regions remain in the form of the circuit pattern. In the case of positive photoresist, the soluble, exposed regions of the photoresist are dissolved and the insoluble, unexposed regions remain in the form of the circuit pattern.

The circuit pattern defined by the developed and hardened photoresist is next transferred to the underlying metal conductive layer using a metal etching process, in which metal over the entire surface of the wafer and not covered by the photoresist is etched away from the wafer with the metal under the photoresist that defines the circuit pattern protected from the etchant. As a result, a well-defined pattern of metallic microelectronic circuits which closely approximates the photoresist circuit pattern remains in the metal layer.

While a number of methods are known in the art for developing photoresist, most commercial developing stations utilize what is known as a spray/puddle method. The spray/puddle method is carried out in three stages. In the first stage, the developer is sprayed onto a wafer mounted onto a spinning wafer chuck. In the second stage, the wafer remains in a static state for carrying out what is known as puddle development. In the third stage, the wafer is cleaned with water and then dried by rotation.

A schematic view of a typical conventional developer dispensing apparatus 2 for dispensing a developing liquid 4 onto a semiconductor wafer 16 is shown in FIG. 1. The apparatus 2 includes an elongated dispensing head 6 having multiple dispensing nozzles 8 through which the developing liquid 4 is dispensed onto the upper surface 20 of the wafer 16. The apparatus 2 further includes a chuck 10 for supporting the wafer 16, a cylindrical knife ring 12 encircling the chuck 10, and an external ring guard 14 which encloses the chuck 10 and the knife ring 12. The chuck 10 typically has an external diameter smaller than that of the wafer 16 such that the peripheral portion of the wafer backside 18 is exposed.

In operation, developing liquid 4 is dispensed from the nozzles 8 of the dispensing head 6 and onto the upper surface 20 of the wafer 16. Simultaneously, the dispensing head 6 migrates horizontally over the wafer 16 as the wafer 16 is spun by the chuck 10 to coat the wafer 16 with the developing liquid 4, which pools and forms a puddle on the wafer surface 20. Next, the developer solution 4 remains on the wafer surface 20 for a period of time sufficient to develop the photoresist thereon. Since capillary action may cause the flow of the developer solution 4 from the surface 20 onto the wafer backside 18 when the wafer surface 20 is being developed, the wafer backside 18 may become contaminated by the developer solution. Accordingly, the wafer backside 18 is rinsed with water jets 22 beneath the chuck 10 to rinse back-flowing developer solution from the wafer backside 18.

Conventionally, the gap between the upper edge of the knife ring 12 and the backside 18 of the wafer 16 is typically about 1.2 mm. This fixed gap distance is optimum, as a gap distance of less than 1.2 mm causes excessive accumulation of developer around the edges of the wafer, whereas a gap distance of greater than about 1.4 mm causes backflow of the developer solution over the wafer backside and contamination of the wafer chuck 10. However, the fixed 1.2 mm gap distance is incapable of completely preventing contamination of the chuck 10 by the developer solution. Furthermore, the fixed gap distance hinders adequate rinsing of the wafer backside after the photoresist development process. Accordingly, a developer dispensing apparatus is needed having a vertically adjustable knife ring to facilitate minimizing the gap distance between the ring and the wafer backside as developer solution is dispensed onto the wafer, and to facilitate increasing the gap distance in order to enhance rinsing of developer solution from the wafer backside.

An object of the present invention is to provide a new and improved developer dispensing apparatus having a vertically-adjustable knife ring.

Another object of the present invention is to provide a new and improved developer dispensing apparatus having a knife ring which prevents or minimizes contamination of a wafer chuck during application of a developer solution to a wafer supported on the chuck.

Still another object of the present invention is to provide a developer dispensing apparatus having a new and improved, vertically-adjustable knife ring, which knife ring enhances thorough rinsing of developer solution from a backside of a wafer after a developer solution is applied to the wafer.

Yet another object of the present invention is to provide a developer dispensing apparatus having a vertically-adjustable knife ring which may be actuated by pressurized air or fluid.

A still further object of the present invention is to provide a novel method of preventing backside contamination of a wafer by developer solution in a developer dispensing apparatus.

### SUMMARY OF THE INVENTION

In accordance with these and other objects and advantages, the present invention is generally directed to a new and improved developer dispensing apparatus which is used to dispense developer solution onto a semiconductor wafer substrate and has a vertically-adjustable knife ring. The knife ring is vertically actuated in the apparatus typically by pressurized air or fluid. In typical application, the gap distance between the upper edge of the knife ring and the backside of the wafer is initially adjusted to a minimum value as the developer solution is dispensed onto the wafer, by adjusting the knife ring to the uppermost position in the apparatus. This prevents or at least minimizes backflow of the solution across the wafer backside and contamination of the wafer chuck. By subsequent lowering of the knife ring, the gap distance is increased to facilitate thorough rinsing of developer solution from the wafer backside.

### BRIEF DESCRIPTION OF THE DRAWINGS

The invention will now be described, by way of example, with reference to the accompanying drawings, in which:

FIG. 1 is a schematic view of a typical conventional, fixed knife blade type developer dispensing apparatus for applying a developer solution to a semiconductor wafer;

FIG. 2 is a schematic view of a developer dispensing apparatus which incorporates the vertically-adjustable knife ring of the present invention;

FIG. 3 is a schematic view of the vertically-adjustable knife ring of the apparatus of the present invention, in the upper position during application of a developer solution to a wafer;

FIG. 4 is a schematic view of the vertically-adjustable knife ring of the apparatus of FIG. 3, with the knife ring in the lower position during rinsing of developer solution from the backside of the wafer; and

FIG. 5 is a flow diagram illustrating a typical process flow sequence in implementation of the developer dispensing apparatus with adjustable knife ring of the present invention.

### DESCRIPTION OF THE PREFERRED EMBODIMENTS

The present invention has particularly beneficial utility in preventing contamination of a wafer chuck or support by developing liquid during the development of photoresist on a semiconductor wafer, as well as facilitating thorough rinsing of developing liquid from the backside of the wafer. However, the invention is not so limited in application, and while references may be made to such developing liquid and semiconductor wafers, the present invention is more generally applicable to both preventing contamination of other surfaces by liquids applied to substrates and facilitating rinsing of surfaces in a variety of industrial and mechanical applications.

Shown throughout the drawings, the present invention is generally directed to a new and improved developer dispensing apparatus which is used to dispense developer solution onto semiconductor wafers for the development of photoresist on the wafers and has a vertically-adjustable knife ring. The knife ring is disposed beneath a wafer chuck or support on which the wafer is supported, and may be selectively situated in various vertical positions to facilitate positioning of the upper edge of the knife ring selected gap distances from the backside of the overlying wafer. Typically, an extendible piston of at least one fluid-actuated cylinder engages the knife ring to facilitate vertical displacement of the knife ring in the apparatus. The fluid-actuated cylinder may be actuated by either pressurized air or by pressurized liquid.

The present invention further includes a method of preventing backside contamination of a wafer by developing liquid as the developing liquid is dispensed onto the wafer, as well as facilitating thorough rinsing of developing liquid from the backside of the wafer after photoresist on the wafer is developed. Accordingly, by selective positioning of the knife ring to an upper position in the apparatus, the gap distance between the upper edge of the knife ring and the backside of the overlying wafer is initially adjusted to a minimum value as the developing liquid is dispensed onto the wafer. This prevents or at least minimizes backflow of the liquid from the upper surface of the wafer, over the wafer edges, across the wafer backside and to the wafer chuck. The gap distance is subsequently increased by lowering of the knife ring in order to facilitate thorough rinsing of excess developing liquid from the wafer backside and enhance passage of the rinsing fluid from the apparatus between the upper edge of the knife ring and the wafer backside.

In a typical embodiment, the adjustable knife ring is suitable for a TEL (Tokyo Electron Limited) developer dispensing apparatus and has a diameter of about 290 mm for a wafer having a 300 mm diameter. However, the knife ring may be suitably sized and adapted for other types of developer dispensing apparatus and is suitable for use with wafers having a diameter of 200 mm.

In use, the vertical position of the knife ring is initially adjusted such that the upper edge of the knife ring is disposed at a gap distance of from typically about 0.1 mm to about 0.4 mm with respect to the backside of the wafer. As the developing liquid is dispensed onto the wafer, this gap distance is sufficient to prevent or at least substantially reduce flow of the developing liquid from the upper surface of the wafer, around the wafer edges, along the backside of the wafer and to the wafer chuck, respectively, by capillary action. After processing, the gap distance is subsequently adjusted to a value of typically from about 1.4 mm to about 1.5 mm, wherein the knife ring is disposed in the lower position beneath the wafer, to facilitate thorough rinsing of the developing liquid from the wafer backside and enhance passage of the rinsing fluid and removed developing liquid between the upper edge of the knife ring and the wafer backside.

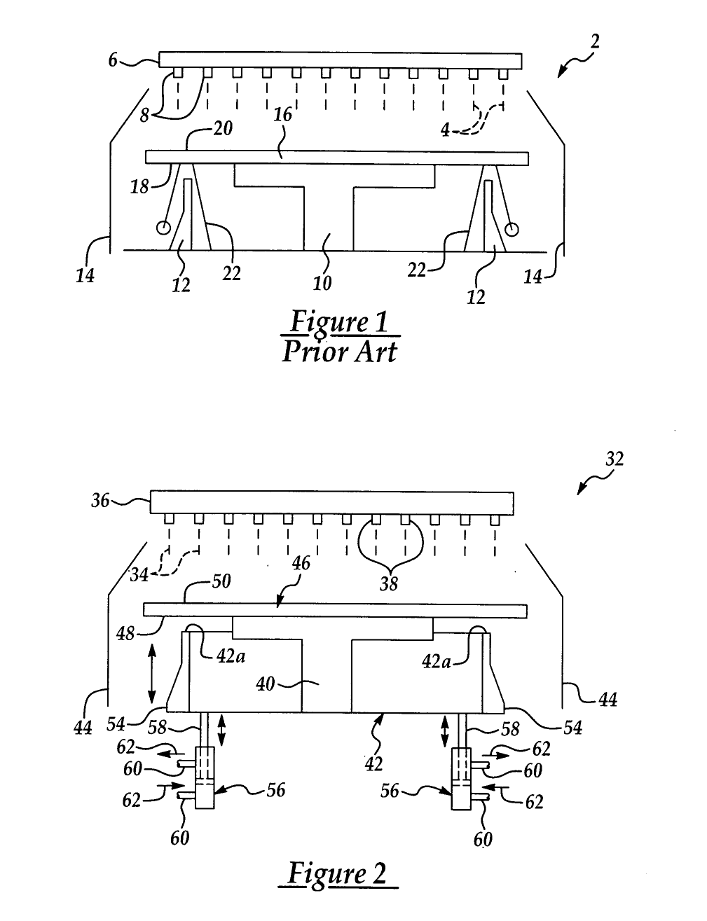

Referring initially to FIG. 2, an illustrative embodiment of a developer dispensing apparatus in implementation of the present invention is generally indicated by reference numeral 32. The apparatus 32 typically includes a chuck 40 for supporting a wafer 46 and an external ring guard 44 which encloses the chuck 40. The chuck 40 typically has an external diameter smaller than that of the wafer 46 such that the peripheral portion of the wafer backside 48 is exposed. An elongated dispensing head 36, having multiple dispensing nozzles 38 through which developing liquid 34 is dispensed onto the upper surface 50 of the wafer 46, is disposed above the chuck 40.

In accordance with the present invention, a generally cylindrical knife ring 42 encircles the chuck 40, inside the ring guard 44. The knife ring 42 typically encircles the chuck 40 and is mounted for selective vertical displacement in the apparatus 32, in the manner hereinafter described. At least one, and typically, multiple ring actuating cylinders 56 are provided in the bottom portion of the apparatus 32. An actuating piston 58 is upwardly-extendible from the ring actuating cylinder 56 and is attached to the ring base 54 of the knife ring 42 according to techniques known by those skilled in the art. Each ring actuating cylinder 56 may be either pneumatic or hydraulic. Accordingly, fluid flow tubes 60 are provided in fluid communication with the interior of each ring actuating cylinder 56 to facilitate flow of the air or liquid fluid pressure 62 between a fluid reservoir (not shown) into and out of the ring actuating cylinder 56, to extend the actuating piston 58 from or retract the actuating piston 58 into the ring actuating cylinder 56. Therefore, flow of the fluid pressure 62 through the bottom fluid flow tube 60 and upwardly in the ring actuating cylinder 56, in the direction indicated by the arrows, facilitates upward extension of the actuating piston 58 from the ring actuating cylinder 56 and upward displacement of the knife ring 42 in the apparatus 32. Conversely, flow of the fluid pressure 62 through the upper fluid flow tube 60 and downwardly in the ring actuating cylinder 56 facilitates retraction of the actuating piston 58 into the actuating cylinder 56 and downward displacement of the knife ring 42 in the apparatus 32. The hydraulic pump and supply mechanism (not shown) for each ring actuating cylinder 56 may be operably connected to a controller (not shown) for automatically controlling the vertical position of the knife ring 42 in the apparatus 32. It is understood that the ring actuating cylinders 56 represent only one example of a suitable mechanism for selectively raising and lowering the knife ring 42 in the apparatus 32, and alternative mechanisms including electric motor and gear systems (not shown), in non-exclusive particular, may alternatively be used for the purpose.

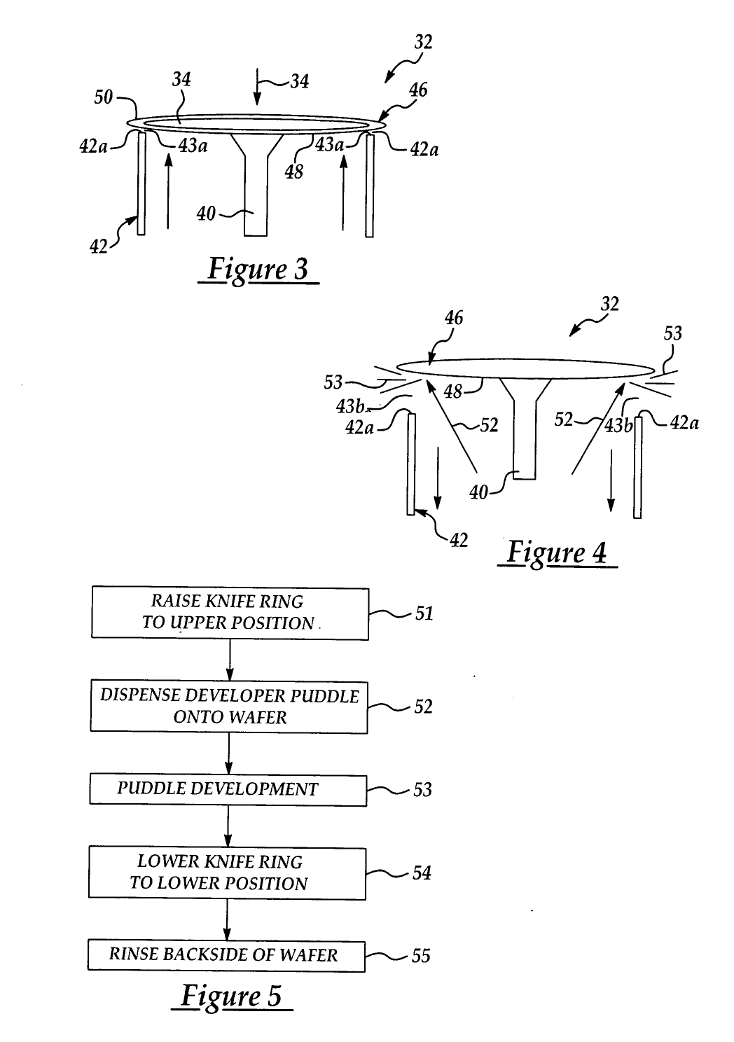

Referring next to FIGS. 2-4, in typical application of the developer dispensing apparatus 32, the wafer 46 is initially placed on the chuck 40 with the photoresist-patterned surface 50 of the wafer 46 facing upwardly. Next, by actuation of the respective ring actuating cylinders 56, the knife ring 42 is lifted in the apparatus 32 until the upper edge 42a of the knife ring 42 is located at a gap distance 43a of from typically about 0.1 mm to about 0.4 mm with respect to the backside 48 of the wafer 46, as shown in FIG. 3. Next, a selected quantity of the developing liquid 34 is dispensed from the nozzles 38 of the dispensing head 36, onto the wafer 46 until a puddle of the developing liquid 34 forms on the wafer 46 as further shown in FIG. 3. Simultaneously, the chuck 40 is operated to rotate the wafer 46 at selected rotational speeds to draw the developing liquid 34 uniformly over the wafer surface 50 by centrifugal force. As it is dispensed onto the wafer 46, the developing liquid 34 has a tendency to flow beyond the edges of the wafer 34 by centrifugal force and across the wafer backside 48 by capillary action. Accordingly, the small gap distance 43a of typically from about 0.1 mm to about 0.4 mm between the wafer backside 48 and the upper edge 42a of the knife ring 42 tends to retard flow of the developing liquid 34 across the wafer backside 48 to the chuck 40, thereby preventing contamination of the chuck 40 by the developing liquid 34. Since the conditioning disc 68 which consists of the hub shaft 72, the hub spacer 76 and the circular disc 74 operates in high torque during the pad conditioning process, the screws 82 that fasten the hub spacer 76 to the hub shaft 72 frequently break under such high torque operating conditions. When a failure, or breakage of the screws 82 occurs, the hub shaft 72 becomes loose from the hub frame 70 and causes a catastrophic failure of the conditioning head 52. Such failure leads to a total breakdown of the chemical mechanical polishing apparatus and a significant drop in the fabrication yield.

After the developing liquid 34 has remained on the wafer 46 in a puddle development phase of selected duration to develop the photoresist thereon, the knife ring 42 is lowered in the apparatus 32 by reverse actuation of the respective ring actuating cylinders 56, until the upper edge 42a of the knife ring 42 is located at a gap distance 43b of from typically about 1.4 mm to about 1.5 mm with respect to the backside 48 of the wafer 46. Next, jets 52 of rinsing fluid such as water are ejected from beneath the chuck 40 against the wafer backside 48 to rinse excess developing liquid 34 from the wafer backside 48. The rinsing liquid spray 53 flows between the wafer backside 48 and the upper edge 42a of the knife ring 42, and is collected in the bottom of the apparatus 32 in conventional fashion. Accordingly, the increased gap distance 43b of typically from about 1.4 mm to about 1.5 mm provides sufficient passage for flow of the rinsing liquid spray 53 and effluent developing liquid from the wafer backside 48 and to the bottom of the apparatus 32.

A typical process flow sequence for a photoresist-developing procedure in implementation of the present invention is summarized in FIG. 5. In step S1, the knife ring is raised to an upper position in the developer dispensing apparatus, defining a gap distance of typically from about 0.1 mm to about 0.4 mm between the upper edge of the knife ring and the backside of the wafer. In step S2, a selected quantity of the developing liquid is dispensed onto the upper, patterned surface of the wafer to form a puddle of the developing liquid on the wafer. Simultaneously, the wafer is rotated at selected rotational speeds to draw the developing liquid over the surface of the wafer for uniform distribution of the developing liquid over the wafer. The small gap distance between the upper edge of the knife ring and the backside of the wafer tends to retard flow of the developing liquid across the wafer backside to the wafer chuck by capillary action. In step S3, the puddle development stage, the developing liquid remains on the photoresist on the wafer to develop the photoresist, as is known by those skilled in the art. In step S4, the knife ring is lowered in the apparatus until the upper edge of the knife ring is disposed at a gap distance of typically from about 1.4 mm to about 1.5 mm with respect to the backside of the wafer. This facilitates thorough rinsing and removal of developing liquid from the wafer backside in step S5 by optimizing flow of rinsing liquid between the backside of the wafer and the upper edge of the knife ring as jets of the rinsing liquid are subsequently directed from beneath the wafer against the wafer.

While the preferred embodiments of the invention have been described above, it will be recognized and understood that various modifications can be made in the invention and the appended claims are intended to cover all such modifications which may fall within the spirit and scope of the invention.

1. An apparatus for dispensing a liquid onto a substrate, comprising:
a support for receiving the substrate;
a dispensing head for dispensing the liquid onto the substrate;
a knife ring vertically adjustably mounted beneath said support; and
a vertical adjustment mechanism operably engaging said knife ring for placing said knife ring at selected vertical positions beneath the substrate.

2. The apparatus of claim 1 wherein said vertical adjustment mechanism comprises at least one fluid-actuated ring actuating cylinder.

3. The apparatus of claim 1 wherein said knife ring has a width of about 290 mm.

4. The apparatus of claim 3 wherein said vertical adjustment mechanism comprises at least one fluid-actuated ring actuating cylinder.

5. The apparatus of claim 2 wherein said at least one fluid-actuated ring actuating cylinder comprises a plurality of fluid-actuated ring actuating cylinders.

6. The apparatus of claim 5 wherein said knife ring has a width of about 290 mm.

7. The apparatus of claim 2 wherein said at least one fluid-actuated ring actuating cylinder is actuated by pneumatic pressure.

8. The apparatus of claim 7 wherein said knife ring has a width of about 290 mm.

9. The apparatus of claim 7 wherein said at least one fluid-actuated ring actuating cylinder comprises a plurality of fluid-actuated ring actuating cylinders.

10. The apparatus of claim 9 wherein said knife ring has a width of about 290 mm.

11. An apparatus for dispensing a liquid onto a substrate, comprising:
a support for receiving the substrate;
a dispensing head for dispensing the liquid onto the substrate;
a knife ring vertically adjustably mounted beneath said support; and
at least one hydraulic-powered ring actuating cylinder operably engaging said knife ring for placing said knife ring at selected vertical positions beneath the substrate.

12. The apparatus of claim 11 wherein said knife ring has a width of about 290 mm.

13. The apparatus of claim 11 wherein said at least one ring actuating cylinder comprises a plurality of ring actuating cylinders.

14. The apparatus of claim 13 wherein said knife ring has a width of about 290 mm.

15.-20. (Cancelled)
